(19) United States
(12) Patent Application Publication
(10) Pub. No.: US 2024/0008422 A1
(43) Pub. Date: Jan. 11, 2024

(54) CLIMATE CELL FOR CULTIVATING PLANTS IN MULTIPLE LAYERS HAVING A SPACE-SAVING AND ENERGY-SAVING CLIMATE SYSTEM

(71) Applicants: KALERA GMBH, München (DE); VIESSMANN REFRIGERATION SOLUTIONS GMBH, Allendorf (DE); ETANOMICS SERVICE GMBH, Mörfelden-Walldorf (DE)

(72) Inventors: Mark KORZILIUS, München (DE); Markus HÄSSLER-MARAUN, Allendorf (DE); Torsten MENZEL, Allendorf (DE); Andreas MAUL, Allendorf (DE); Timm RÖSSEL, Allendorf (DE); Frank WINTERS, Allendorf (DE); Thomas HECKER, Mörfelden-Walldorf (DE)

(21) Appl. No.: 17/796,502

(22) PCT Filed: Jan. 29, 2021
(86) PCT No.: PCT/EP2021/052220

§ 371 Date: Jul. 29, 2022

(30) Foreign Application Priority Data
Jan. 31, 2020 (DE) 10 2020 102 525.4
May 4, 2020 (DE) 20 2020 102 464.7

(51) Int. Cl. A01G 9/24; A01G 9/02

(52) U.S. Cl. CPC A01G 9/246; A01G 9/023; A01G 9/249; A01G 9/0295

(57) ABSTRACT

In order to create a closed climate cell 100 for raising plants in several layers 12 arranged one above the other, wherein the climate cell 100 comprises at least one chamber 10, in which the layers 12 are arranged one above the other, and extend from a first side 11a of the chamber 10 to a second side 11b of the chamber 10, wherein each layer 12 has at least one plant-raising container and at least one lighting platform arranged thereover, wherein a climate is set in at least one chamber 10 by means of a climate system 20 of the climate cell 100, which has both a space-saving and an energy-saving system for adjusting the climate, it is proposed that a respective heat-storing element 13 be arranged on the first 11a and second 11b side of the at least one chamber 10, wherein an air flow 25 generated by a ventilation system 21 of the climate system 20 flows through both heat-storing elements 13, wherein one of the two sides 11a, 11b at least at one point in time forms an air inlet side 23, and the remaining side an air outlet side 24 for the air flow 25, wherein the heat-storing element 13 arranged at the air inlet 23 functions as a heat-emitting element 13a, and the heat-storing element 13 arranged at the air outlet 24 functions as a heat-receiving element 13a.

The invention relates to a closed climate cell for raising plants in several layers arranged one above the other, wherein the climate cell comprises at least one chamber, in which the layers are arranged one above the other, and extend from a first side of the chamber to a second side of the chamber, wherein each layer has at least one plant-raising container and at least one lighting platform arranged thereover. A climate system of the climate cell is used to set a climate in the at least one chamber.

As already known, plants can be raised in greenhouses with a regulated climate. It is here customary to use artificial light in the evening hours and winter months, so as to promote the growth of the plants. Also known is to install a fan or air exchange system in the greenhouses, which ensure that air is exchanged or fresh air is supplied, and can also be used to regulate the air composition, such as oxygen content, CO₂ content or humidity.

### PRIOR ART

Described in DE 1 778 624 A is a device for conditioning air for a climate chamber. A circulating fan is used herein to distribute and circulate air in a climate chamber in an essentially closed circuit, wherein a conditioning unit can humidify, dehumidify, cool, and heat the air. However, the air is here adjusted centrally by the conditioning unit, and then circulated in the complete climate chamber before again returning to the conditioning unit.

Described in DE 10 2016 121 126 B3 is a climatically closed climate cell for raising plants in interior spaces, wherein several containers are arranged above each other in at least two layers within the climate cell. Each container has a receiving area with a flatly arranged substrate for receiving the plants and/or receiving seeds, wherein the container has a frame that circumferentially surrounds the receiving area.

### PRESENTATION OF THE INVENTION: OBJECT, SOLUTION, ADVANTAGES

The object of the present invention is to improve a closed climate cell for raising plants in several layers arranged one above the other in relation to the air conditioner inside of the climate cell in such a way as to give the air conditioner a very space-saving structural design. The advantage to a simple structural design for the climate system of the climate cell is not just that assembly is less complex, but also that using fewer ventilators and a simpler cooler and reheater with heat recovery saves on energy. In addition, the new construction concept offers a very homogeneous temperature distribution and a uniform temperature for all plants, in which the latter only fluctuates by a few degrees, even if the climate cell reaches a large size. In addition, the construction concept is very flexible, since air can be blown in from both sides, and thus adapted for varying climate chamber sizes and climate cells.

According to the invention, a closed climate cell for raising plants in several layers is provided for this purpose, wherein the climate cell comprises at least one chamber, in which the layers are arranged above each other, and extend from one first side of the chamber to a second side of the chamber, wherein each layer has at least one plant-raising container and at least one lighting platform arranged thereover. A climate is set in at least one chamber by means of a climate system of the climate cell.

For this purpose, a respective heat-storing element is arranged on the first and second side of the at least one chamber, wherein an air flow generated by a ventilation system of the climate system flows through both heat-storing elements, wherein one of the two sides at least at one point in time forms an air inlet side, and the remaining side an air outlet side for the air flow, wherein the heat-storing element arranged on the air inlet side of the chamber functions as a heat-emitting element at this point in time, and the heat-storing element arranged on the air outlet side functions as a heat-receiving element at this point in time.

According to the invention, a closed climate cell is understood as a climate cell closed on six sides for raising plants in an indoor space. The climate system is used to adjust or correspondingly regulate the climate inside of the closed climate cell based upon on the requirements of the plants, including as a function of the respective growth phase. To this end, in particular the temperature, humidity, carbon dioxide content, oxygen content and flow rate of the air are set. An advantage to the closed climate cell is here in particular that less water is consumed by comparison to conventional cultivation methods, since not a lot of moisture escapes in the closed system, and thus less water has to be added for the plants.

The plant-raising containers can be trough-shaped in design, and have one or several receiving areas for plants or seeds. Several plant-raising containers can be arranged side by side in a trough-shaped carrier. Arranged in the receiving area of each plant-raising container is a substrate, upon which the seeds or plant rests. The corresponding nutrient solution is preferably guided along below the substrate.

The lighting platform preferably has essentially the same outer dimensions as the plant-raising container or the carrier with several plant-raising containers arranged side by side. Each lighting platform can have several lighting means, in particular LEDs, and optionally sensors and/or cameras as well. The lighting means can preferably also consist of hybrid light, i.e., a mixture of daylight and artificially generated light. For example, the daylight can be guided into the closed climate chamber via mirrors and fiberglass, and there distributed. Sensors can measure the strength and composition of the daylight, and control the lighting means so as to enhance missing components within the spectrum of daylight, for example with LED's. The lighting means can be used to adjust the lighting to the conditions of the plants, depending on the current growth phase. For this purpose, the lighting platforms or lighting means of the lighting platforms can preferably be automatedly actuated. The optional sensors and/or cameras can be used to determine the actual state of the climate inside of the closed climate cell, as well as the current growth phase of the plants. The lighting platforms and/or climate system or ventilation system or climate-regulating elements secured between the chambers can then be controlled based upon these data.

A chamber of the climate cell here consists of several layers arranged one above the other, which are fastened to the opposing sides of the chamber. Each side here has its own air inlet or air outlet, and can preferably carry a flow of air over the entire width. This means that air or the generated air flow enters the chamber through a first side of the chamber, flows through the chamber, and exits the chamber again on a second side. The chambers can also be arranged one above the other.

If several chambers are arranged side by side, the first side of the second chamber is arranged next to the second side of the first chamber, so that the air leaving the first chamber can penetrate into the second chamber through its first side after flowing through an intermediate space between the two chambers. The intermediate space is here preferably distinctly narrower than a chamber. This makes it possible to place many chambers side by side in a climate cell. It is also possible to place the chambers one behind he other, so that several rows with chambers placed side by side are arranged one after the other. However, these chambers placed one after the other preferably have no shared air circulation, but are preferentially adjusted and/or regulated in a climatically independent manner by means of the climate system or another climate system. For example, a respective ventilation system could be allocated to each row of chambers, and generate a respective air flow that flows through all chambers in a row arranged side by side.

A heat-storing element is fastened in or on the first or second side of the chamber, wherein, depending on the direction of the air flow of the ventilation system, the heat-storing element can be a heat-emitting element or a heat-receiving element, or functions as a heat-emitting or heat-receiving element. For purposes of this invention, the heat-storing element always functions as a heat-emitting element at a point in time, and at this point in time is arranged on the air inlet side of a chamber. The heat-storing element, which at this point in time is arranged on the air outlet side of the same chamber, functions as the heat-receiving element at this point in time. The heat-storing elements can thus switch their function between heat-receiving and heat-emitting. For example, this can be done through air flow reversal.

According to this invention, a heat-storing element has a heat-emitting function if it emits stored heat to the air flow that flows through this heat-storing element. Conversely, a heat-storing element has a heat-receiving function if it receives heat from the air flow that flows through this heat-storing element, and thus cools the air flow.

Given chambers arranged side by side, the heat-receiving element of the chamber lying first in the air flow is arranged next to the heat-emitting element of the chamber lying second in the air flow, wherein both elements or the chambers are separated by an intermediate space. Even more elements of the climate system can be placed or have been placed in this intermediate space, for example a climate-regulating element. For example, one such climate-regulating element can preferably be used for cooling air and/or regulating moisture.

The ventilation system comprises an air-moving element and/or an element that generates the air flow. For example, a ventilator can be provided for this purpose, and can be fastened to one or both sides of the climate cell in an edge space. It is also possible to fasten edge spaces at both ends of a row of chambers arranged side by side, which preferably are both equipped with a ventilation system. The edge spaces thus to some extent form the beginning and end of a row of chambers arranged side by side, and follow the first side of the first chamber and second side of the last chamber in place of an intermediate space. The ventilation system determines the direction of air flow in the climate cell or the chambers.

The at least one chamber of the closed climate cell preferably consists of at least one upper and at least one lower level. The levels are here preferably structurally separated, so that no notable air exchange is possible between the level. The structural separation is ideally such that the individual chambers are separated, to include the intermediate spaces lying in between, so that an air flow running in the upper level and an air flow running in the lower level can flow independently of each other. It is especially preferable that the air flow of the upper level and the air flow of the lower level be directed in a respectively opposite direction. If more than two levels are present in the chamber, it is possible that the direction of air flow always be alternately directed in an opposite direction between two levels, so that the air flows either through two respective levels in a kind of annular circulation, or serpentine-like through all levels in alternating directions. Given several levels, it is also possible for the air to flow through several levels in the same direction, so that no change in direction of the air flow takes place between all levels. It is especially preferred that each levels consists of a similar number of layers, so that the distances between the levels are roughly equidistant.

The direction of the air flow that flows through the at least one chamber can preferably be changed and/or switched. This means that the air flow on one level can alternatingly flow in a first direction and in an opposite second direction. A change in direction of the flow can here refer to any change in direction, but in particular to a flow in the direction opposite the previous direction of flow on the same level. The air flow preferably flows for 10 seconds to 3 minutes in one direction before the direction is changed. It is especially preferred for the air flow to flow in one direction for 60 seconds to 2 minutes, especially preferably for 90 seconds to 100 seconds, before a change in direction takes place. If a change in direction takes place, the air flow preferably also flows in the other direction for exactly as long as it flowed in the one direction, so that the changes in direction occur in equal periods. It is preferable that the air flow briefly pause given a change in direction, meaning that the air flow comes to a stop for a brief time, in particular for less than 20 seconds, preferably for less than 10 seconds. The air flow can here be brought to a stop by not turning on ventilation systems on both sides. However, the air flow can also be slowed or stopped by turning off a ventilation system in an edge area on the one side of the climate cell, and turning it on in the edge space of the opposite side of the climate cell, so that the fastest possible change in direction can be realized.

It is further preferably provided that the closed climate cell has a ventilation system, with which the direction of the air flow can be changed and/or switched. The ventilation system preferably comprises a ventilator; alternatively or additionally, the ventilation system can comprise a blower or compressor. It is important that the ventilation system be able to control the direction of an air flow.

It is further preferably provided that the heat-storing elements be rigidly arranged on the first or second side of the chamber. A rigid arrangement here means that the elements are fixedly, i.e., immovably, connected with the first or second side of the chamber. The heat-storing elements can be installable and removable, but not movable relative to the respective side of the chamber. The heat-storing elements here build the air inlet and air outlet of the chamber, i.e., structurally close the latter, but are themselves permeable to air, for example through holes or passageways. For example, the heat-storing elements can be mounted on the fastening framework of the layers. It is especially preferred that the function of the two heat-storing elements be switched after a change in direction of the air flow, specifically in such a way that the element that previously functioned as heat-emitting functions as the heat-receiving element, and the element that previously functioned as heat-receiving functions as the heat-emitting element. The advantage to this is that the heat-receiving and heat-emitting element switch, wherein the initially heat-receiving element here extracts heat from the air flowing through, which it can then, when it functions as the heat-emitting element, again releases to the air now flowing through in the opposite direction. Therefore, the storage of heat in the heat-storing element allows energy to be transferred, and thus economized, since use is made of the fact that the air at the air inlet and at the air outlet of the chamber has different temperatures, and, due to the reversal of the air inlet and air outlet along with the temporary storage of the energy emitted by the air at the air outlet in one of the air-storing elements, can be reused during air entry after the reversal.

As an alternative to a change in direction of the air in the closed climate cell, the element of the upper level of the at least one chamber that functions to emit heat at one point in time can preferably be connected with the element of the lower level of the at least one chamber that functions to receive heat at this point in time in such a way that the two elements are movably interchangeable. Movable can here be understood as a turning, swiveling and/or rotation or some other movement of the two elements with each other or relative to each other. The heat-storing elements of the at least two levels are preferably connected in pairs over the levels, so that elements on the same side of the chamber with different functions, i.e., heat-emitting or heat-receiving, are connected with each other. This means that the heat-emitting element of the air inlet of the upper level is connected with the heat-receiving element of the air outlet of the lower level, and the heat-receiving element of the air outlet of the upper level is connected with the heat-emitting element of the air inlet of the lower level. In particular, it is preferred that the two elements of the first and second side can each be turned, swiveled, rotated, or otherwise moved around each other, so that they can readily switch their position. The elements can here also be mounted so as to be easily offset relative to each other, so that moving the elements up and down causes a switch to take place.

Alternatively, the two elements can be two halves of a rotationally symmetrical body, so that the two connected heat-storing elements form two parts of a rotor. The rotation here changes the part of the body that receives heat and the one that emits heat, but not the position of the heat-emitting element, which is always arranged at the air outlet, or of the heat-receiving element, which is always arranged at the air inlet. During the rotation of the heat-storing elements of two levels, it is thus especially preferred that the element of the first level with a heat-receiving function be switched to an element of the second level with a heat-emitting function, and that the element of the first level with a heat-emitting function be switched to an element of the second level with a heat-receiving function.

The two connected, heat-storing elements preferably move continuously. This leads to a constant change in the two heat-storing elements, and a continuous switching between the heat-receiving and heat-emitting element. The advantage to this is that the temperature of the body in the respective area of the air inlet and air outlet is very constant. More precisely stated, the temperature progression of the continuously moving heat-storing element in the air inlet area of a first level reveals the warmest element temperature coming directly after the air outlet area of a second level in the rotational direction, wherein the other area of the air inlet area of the first level lying in front of the air outlet area of the second level in the rotational direction is somewhat colder by comparison thereto. The temperature gradient is exactly the other way around for the air outlet area, with the area following the air inlet of a second level being colder than the area of the air outlet area of a first level, which lies in front of the air inlet area of a second level in the rotational direction.

As an alternative to a continuous movement, the movement of the two connected, heat-storing elements can preferably take place in discrete steps. The movement of the heat-storing elements can here happen in regular time intervals, for example of at most 1 minute, preferably less than 30 seconds, especially preferably less than 10 seconds, in even, periodic intervals. For example, it is possible that a rotation by 30°, 60°, 120° or 180° always be performed here. Depending on the shape of the heat-storing elements, it can also be the case that only one rotation by exactly 180° is possible if the body is not rotationally symmetrical. However, given a horizontally offset installation of the two heat-storing elements, an upward or downward movement of the elements can also result in a switching of places. If a rotation of elements is present, i.e., the movement is a rotation, a temperature gradient again exists within the heat-storing elements, so that the air inlet area of a first level that comes directly after the air outlet area of a second level in the rotational direction has a warmer element temperature than the area of the inlet area that comes before the air outlet area of the second level in the rotational direction. Conversely, the area of the air outlet area of a first level that comes directly after the air inlet area of a second level in the rotational direction has a colder temperature than the area of the air outlet area of the first level that is arranged directly in front of the air inlet area of the second level in the rotational direction.

The closed climate cell preferably comprises several chambers, which preferably are arranged side by side, so that the air flow passes through the chambers one after the other. This means that the air flow, as it exits one side of the first chamber, flows through a short intermediate space between the chambers, to thereafter flow through the side of the second chamber that faces the first chamber. While the air flow circulates, it flows through all chambers simultaneously. As a result, an air flow can pass through several chambers, and if present, the intermediate spaces between the chambers, one after the other in the same direction.

It is especially preferred that a climate-regulating element be secured in an intermediate space between two adjacent chambers of the closed climate cell and/or on one side of an individual chamber. For example, the climate-regulating element can here be an element for cooling air or regulating moisture. For example, the air can here be cooled by cold air flowing in, or by introducing other cold substances, such as cold water droplets. Moisture regulation can here involve both a moisture reduction and a moisture increase, wherein a moisture reduction can take place with air dehumidifiers, for example via sorptive materials, or through condensation on cold water droplets or cold surfaces. If the air is to be cooled by cool water, any potential contaminants and impurities could also be dissolved from the air, as during “air washing”. The advantage offered by the climate-regulating element in the intermediate spaces of the chamber is that the air can be regulated after each chamber, so that controlled climate conditions predominate at the beginning of each chamber. Measuring devices can preferably also be installed in the intermediate spaces, which control the air, so that the air conditions can be readjusted. It is also possible to set the chambers to varying climate conditions, for example if the plants in varying growth stages are present in the chambers, and other temperatures or humidities are ideal.

It is preferably further provided that the heat-storing element has or consists of heat-conducting material, in particular metal, preferably aluminum. Various heat-conducting materials are here possible, with the heat storage capacity of the heat-conducting material being of primary importance.

In addition, the heat-storing element has several oblong passageways, and preferably consists of a honeycomb structure, or has one. In this case, oblong passageways means that the diameter of the passageway is smaller than the length of the passageway, wherein the length in particular is at least twice as long as the diameter, the length is especially preferably at least five times as long as the diameter, and the length very especially preferably corresponds to ten times the diameter, of the passageway. It is likewise possible for the heat-storing element to have a lamellar structure or be constructed out of a spiral, wherein smaller structures such as bars or shafts are secured between the circles or spiral arms. The shafts can here also be arranged between the spiral arms, so that the maximums and minimums each contact adjacent spiral arms.

The temperature change or moisture change of the air of the ventilation system will here be described as an example for climate regulation of a chamber with an accompanying intermediate space: A temperature of the air of the ventilation system is preferably increased by a heat-emitting element as air enters into the chamber, and after the air has entered into the chamber will rise until air exits the latter, so as to then be lowered at the air outlet from the chamber by the heat-receiving element, and possibly after the chamber in an intermediate space by a climate-regulating element.

For example, the temperature at the air inlet into the chamber can be heated from 20° C. to 22° C. as it passes the heat-emitting element. For example, the temperature in the chamber can rise from 22° C. to 25° C., wherein this rise can be attributed primarily to waste heat of the lighting system. For example, the heat-receiving element cools the air from 25° C. to 23° C. at the air outlet of the chamber, wherein it can be further cooled from 23° C. to 20° C. in the intermediate space between two chambers, in particular by a climate-regulating element. In the intermediate space, the air humidity can additionally be lowered from 85% to 65%, since the air humidity increases as the flow passes through the chamber. Ideally, the climate-regulating element in the intermediate space between the chambers is both an air-cooling element, and also responsible for setting the air humidity. The climate-regulating element can especially preferably also regulate the CO2- and/or oxygen concentration of the air.

### DESCRIPTION OF THE FIGURES

The invention will be exemplarily explained below based upon preferred embodiments.

Shown schematically on:

FIG. 1: is a climatically closed climate cell with several chambers,

FIGS. 2a, b: is a side and front view of a heat-storing element,

FIGS. 3a, b: is the air flow of a climate system at two different points in time, and

FIGS. 4a, b: is the rotation of a heat-storing element during the operation of the closed climate cell.

### PREFERRED EMBODIMENTS OF THE INVENTION

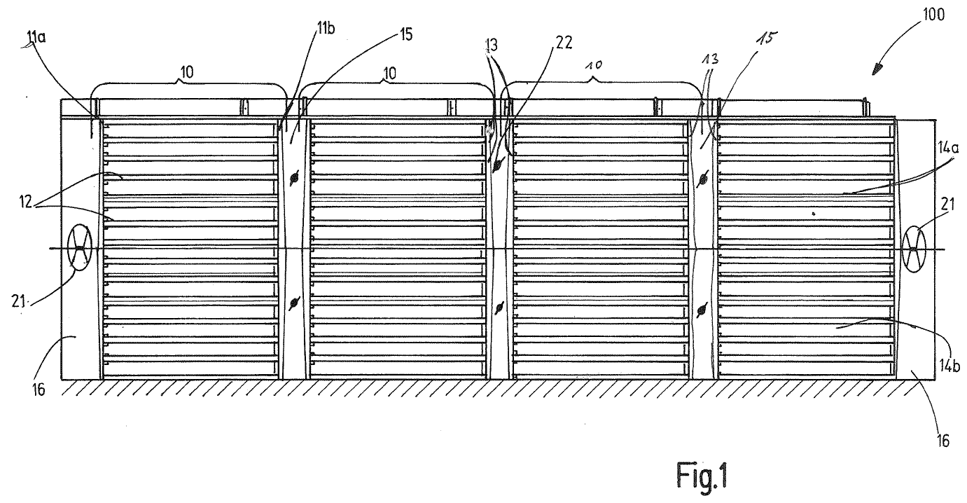

FIG. 1 shows a closed climate cell 100 for raising plants, for example which consists of four chambers 10. The chambers 10 are arranged side by side, and separated from each other by a small intermediate space 15. However, the chambers 10 and intermediate spaces 15 lie completely inside of the closed climate cell 100.

The chambers 10 each comprise several layers 12, which comprise one or several plant-raising containers and one or several lighting platforms arranged thereover. The layers 12 extend from a first side 11a of the chamber 10 to a second side 11b of the chamber, and are secured over the complete height of the chamber 10.

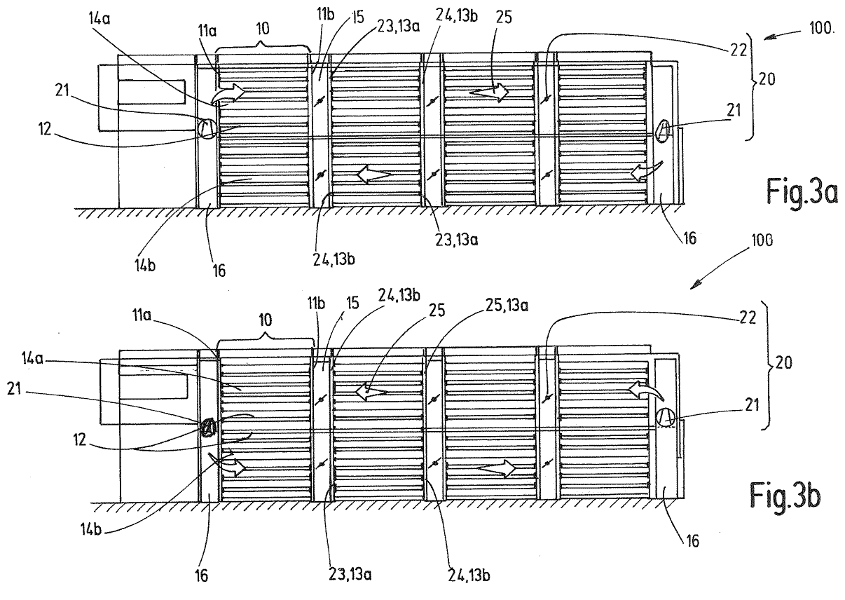

One or several respective heat-storing elements 13 are arranged on the first side 11a and second side 11b of the chamber 10, through which an air flow 25 generated by a ventilation system 21 of a climate system 20 (see FIG. 3) can or does flow. A climate-regulating element 22 is arranged in the intermediate space 15, between the heat-storing elements 13 or sides 11a, 11b of adjacently lying chambers 10.

The air is guided through the chambers 10 by a ventilation system 21, which is secured in an edge space 16 that closes the closed climate cell 100 on both sides. The chambers 10 comprise a first level 14a, which is arranged in the upper area of the chambers 10, and a second level 14b structurally separated therefrom, which forms the lower area of the chambers 10. The intermediate spaces 15 are also divided into two levels 14a, 14b in this way. The air circulated in the climate cell 100 here always flows in the same direction within a level 14,a, 14b, but can preferably flow in differing directions in the two different levels 14a, 14b. Therefore, the levels 14a, 14b are split in such a way that an air flow 25 cannot overcome the structural separation.

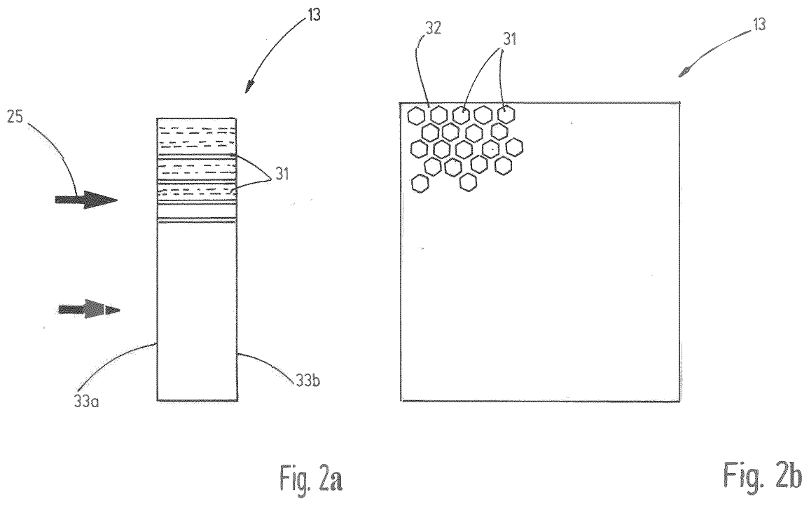

FIG. 2a shows a side view of a heat-storing element 13, through which an air flow 25 flows from left to right. The air flow 25 here flows through passageways 31 in the heat-storing element 13, which extend completely from the front side 33a to the rear side 33b. As a result, the surface structure of the heat-storing element 13 on the front side 33a is identical to the rear side 33b. A heat-conducting material 32 is located between the passageways 31, and has the heat-storing element 13, or which the heat-storing element 13 consists of. While the passageways 31 shown on FIG. 2a run straight through the heat-storing element 13, they can also be curved or bent in another embodiment.

FIG. 2b shows a front view of a heat-storing element 13, which depicts the inlet of the passageways 31. Bars comprised of heat-conducting material 32 are shown between the passageways 31. The honeycomb structure of the passageways 31 of the heat-storing element 13 is readily visible. The diameter of the passageways 31 is here distinctly smaller than the length of the passageways 31, thus yielding an elongated structure with thin passageways 31, as also discernible on FIG. 2a. The heat-conducting material 32 is also heat-storing. While the exterior shape of the heat-storing element 13 can here be square or rectangular or round, the heat-storing element 13 can also have some other kind of shape.

FIG. 3a shows a closed climate cell 100, for example which consists of four chambers 10 that are separated from each other by an intermediate space 15. The closed climate cell 100 is here divided into two levels 14a, 14b, wherein both the chambers 10 and the intermediate spaces 15 are divided into these two levels 14a, 14b by a structural separation. The first level 14a is here the upper level, and the second level 14b is the lower level. The division into two levels 14a, 14b does not extend through the edge spaces 16, which are arranged before the first chamber 10 and after the last chamber 10, and thus close the climate cell 100 in a horizontal direction.

A respective ventilation system 21 is secured in the edge spaces 16, for example a ventilator. The chambers 10 are bounded by a first side 11a and a second side 11b, wherein layers 12 are arranged between the sides 11a, 11b within the chambers, lying vertically above each other and running horizontally. Each layer 12 here consists of one or several plant-raising containers, and one or several lighting platforms arranged thereover.

A respective heat-storing element 13 is secured on the first side 11a and second side 11b of a chamber 10 in each of the levels 14a, 14b, through which air or the air flow 25 can flow into the chamber 10 and out of the chamber 10. The chambers 10 and intermediate spaces 15 of the first level 14a and second level 14b are thus connected with each other in such a way that an air flow 25 can flow through a level 14a, 14b unimpeded.

Shown on FIG. 3a is an air flow 25 flowing counterclockwise through the first level 14a, which is the upper level, and the second level 14b, which is the lower level, which is maintained or generated by the operation of the ventilation system 21 on the left side in the edge space 16. After the edge space 16, the air flow 25 here first flows through the heat-storing element 13 of the first side 11a of a chamber 10, which realizes the air inlet 23 into the chamber and functions as a heat-emitting element 13a. During entry of the air flow 25 into the chamber 10, this heat-storing element 13 thus emits stored heat to the air flow 25. Inside of the chamber, the air flow 25 is further heated by the lighting unit, for example. At the air outlet 24 of the chamber 10 on the second side 11b, the heat-storing element 13 functions as a heat-receiving element 13b. As a consequence, this heat-storing element 13 receives stored heat from the air flow 25 as the air flow 25 exits the chamber 10, and thereby cools the air flow.

The air of the air flow 25 then flows into an intermediate space 15, in which a climate-regulating element 22 is secured. The climate-regulating device 22 can be controlled by an external regulator, and thereby readjust, set, or regulate the air between the first and second chamber.

At the beginning of the second chamber 10, the air now flows through the first side 11a again and a heat-emitting element 13a through the air inlet 23 into the chamber 10 and, at the air outlet 24, through the heat-receiving element 13b of the second side 11b of this chamber 10 into the next intermediate space 15.

At the end of the first level 14a, the air flow 25 in the edge space 16 is guided into the second level 14b, and there flows back in the opposite direction, so that it first passes the second side 11b of the chamber 10, which constitutes the air inlet 23 of this chamber 10 with the heat-emitting element 13a. After flowing through the chamber 10, the air flow 25 exits the chamber 10 through the air outlet 24 on the first side 11a of the chamber 10 through the heat-receiving element 13b, so as to get into the intermediate space 15.

During operation of the closed climate cell 100, this air flow 25 or direction of air flow 25 is maintained for several seconds, preferably 10 s to 3 min, especially preferably 60 s to 120 s, and very especially preferably 90 s to 100 s.

As shown on FIG. 3b, the direction of the air flow 25 is then reversed, so that the air is no longer driven by the ventilation system 21 of the edge space of the left side of the closed climate cell 100, but rather by the ventilation system 21 on the edge space 16 of the opposite side (depicted on the right here). As a result, the air of the air flow 25 flows counterclockwise through the first and second level 14a, 14b. The air flow 25 on the first level 14a here first passes the second side 11b of a chamber 10, wherein the heat-emitting element 13a is located at the air inlet 23. After flowing through the chamber 10, the air at the air outlet 24 passes through the heat-receiving element 13b on the first side 11a of the chamber into the intermediate space 15, in which a climate-regulating element 22 is secured. On the second level 14b, the air flow 25 passes through the air inlet 23 during entry into the chamber 10, i.e., through the heat-emitting element 13a on the first side 11a of the chamber 10. After flowing through the chamber 10, the air again exits at the air outlet 24 through the heat-receiving element 13b on the second side 11b of the chamber 10. While the climate-regulating element 22 as well as the ventilation system 21 are part of the climate system 20, it can also comprise even more elements, for example measuring devices, sensors and/or additional regulating units.

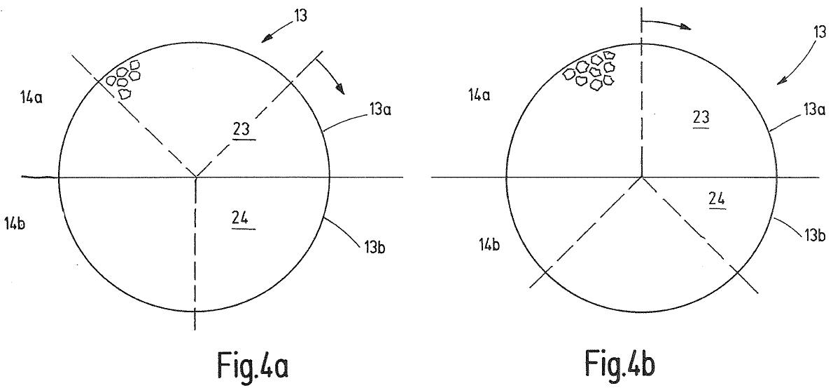

FIG. 4 schematically shows how a rotation of the heat-storing element 13 can be used for switching between the heat-emitting element 13a and heat-receiving element 13b, instead of for changing the direction of the air flow 25. The heat-storing element 13 is located in part at the height of the first level 14a, and in part at the height of the second level 14b, wherein the element is arranged on the first side 11a or second side 11b of the chamber 10. The heat-storing element 13 can here consist of one or several parts, which are arranged at the same height, i.e., directly above each other, but can also be arranged offset from each other. One way of switching the heat-storing elements 13 involves rotating the heat-storing elements 13 around a shared middle point, wherein the first level 14a on FIG. 4a represents the air inlet 23, in which the heat-emitting element 13a is arranged, and the second level 14b represents the air outlet 24, in which the heat-receiving element 13b is arranged. The heat-storing element 13 was here exemplarily rotated by 60° on FIG. 4b, which now turned part of the previously heat-emitting element 13a of the first level 14a into a heat-receiving element 13b in the second level 14b. As usual, the air inlet 23 is located on the first level 14a, and the air outlet 24 on the second level 14b.

### REFERENCE NUMBERS

100 Climate cell
10 Chamber
11a First side
11b Second side
12 Layer
13 Heat-storing element
13a Heat-emitting element
13b Heat-receiving element
14a First level
14b Second level
15 Intermediate space
16 Edge space
20 Climate system
21 Ventilation system
22 Climate-regulating element
23 Air inlet
24 Air outlet
25 Air flow
31 Passageway
32 Heat-conducting material
33a Front side
33b Rear side

1. A closed climate cell for raising plants in several layers arranged one above the other, wherein the climate cell comprises at least one chamber, in which the layers are arranged one above the other, and extend from a first side of the chamber to a second side of the chamber, wherein each layer has at least one plant-raising container and at least one lighting platform arranged thereover, wherein a climate is set in at least one chamber by a climate system of the climate cell,
wherein a respective heat-storing element is arranged on the first and second side of the at least one chamber, wherein an air flow generated by a ventilation system of the climate system flows through both heat-storing elements, wherein one of the two sides at least at one point in time forms an air inlet side, and the remaining side an air outlet side for the air flow, wherein the heat-storing element arranged on the air inlet side functions as a heat-emitting element, and the heat-storing element arranged on the air outlet side functions as a heat-receiving element.

2. The closed climate cell according to claim 1,
wherein the at least one chamber of the climate cell comprises of at least one first and one second level, and the air flow in the first level and second level is directed in the respectively opposite direction.

3. The closed climate cell according to claim 1,
wherein a direction of the air flow through the at least one chamber configured to can be changed and/or switched.

4. The closed climate cell according to claim 3,
wherein the climate cell has a ventilation system, which is configured to change and/or switch the direction of the air flow.

5. The closed climate cell according to claim 1,
wherein the heat-storing elements are rigidly arranged on the first or second side of the chamber.

6. The closed climate cell according to claim 3,
wherein after a change in direction of the air flow, the function of the two heat-storing elements is switched, such that the element that previously functioned as heat-emitting functions as a heat-receiving element, and the element that previously functioned as heat-receiving functions as a heat-emitting element.

7. The closed climate cell according to claim 2,
wherein the element of the first level of the at least one chamber that functioned as heat-emitting at one point in time is movably connected with the element of the second level of the at least one chamber that functioned as heat-receiving at this point in time.

8. The closed climate cell according to claim 7,
wherein during the movement of the heat-storing elements of two level, the element of the one level with a heat-receiving function is switched to an element of the other level with a heat-emitting function, and the element of the one level with a heat-emitting function is switched to an element of the other level with a heat-receiving function.

9. The closed climate cell according to claim 7,
wherein the two connected, heat-storing elements form two parts of a rotor.

10. The closed climate cell according to claim 7,
wherein the movement of the two connected, heat-storing elements takes places continuously.

11. The closed climate cell according to claim 7,
wherein the movement of the two connected, heat-storing elements takes places in discrete steps.

12. The closed climate cell according to claim 1,
wherein the climate cell has several chambers, which preferably are arranged side by side, so that the air flow flows through the chambers one after the other.

13. The closed climate cell according to claim 1,
wherein a climate-regulating element is secured in an intermediate space between two adjacent chambers and/or in an edge space on one side of an individual chamber.

14. The closed climate cell according to claim 1,
wherein the heat-storing element comprises heat-conducting material, in particular metal, preferably aluminum.

15. The closed climate cell according to claim 1,
wherein the heat-storing element has several elongated passageways, and comprises a honeycomb structure.
